(19) United States
(12) Patent Application Publication
(10) Pub. No.: US 2023/0234280 A1
(43) Pub. Date: Jul. 27, 2023

(54) THERMOPLASTIC COMPOSITE MATERIAL AND PRESS DIES THEREFROM

(71) Applicant: 3D Systems, Inc., Rock Hill, SC (US)

(72) Inventors: Jeffrey Jacob Cernohous, Hudson, WI (US); William Dean Macy, Woodland Park, CO (US)

(21) Appl. No.: 18/158,507

(22) Filed: Jan. 24, 2023

Related U.S. Application Data
(60) Provisional application No. 63/302,814, filed on Jan. 25, 2022.

(51) Int. Cl. B29C 64/118; B33Y 10/00; B33Y 80/00; B33Y 70/10; B21D 37/10

(52) U.S. Cl. CPC B29C 64/118; B33Y 10/00; B33Y 80/00; B33Y 70/10; B21D 37/10; B29K 2101/12

(57) ABSTRACT

Processes and material compositions are disclosed for applying polymer additive manufacturing to producing press dies, such as for sheet metal forming. As disclosed in various embodiments, material compositions comprise a thermoplastic, a first filler having low aspect ratio particles and a second filler having high aspect ratio. In at least one embodiment, composites according to the disclosed teachings have a compressive modulus greater than 3500 MPa and a compressive strength greater than 70 MPa, such that the composites have sufficient mechanical properties for press tooling and are amenable to extrusion-type additive manufacturing processes. In at least one embodiment, the use of the disclosed composites with additive manufacturing enables reduced overall mass of tooling by inclusion of voids inside the die.

### RELATED APPLICATIONS

This application claims the benefit of priority under 35 U.S.C. 119(e) to U.S. provisional patent application No. 63/302,814, which was filed on Jan. 25, 2022 and is incorporated by reference herein.

### TECHNICAL FIELD

This disclosure relates to producing dies for use in presses to reshape malleable sheet stock and, more particularly, to using an additive manufacturing process in conjunction with an adapted thermoplastic composition to efficiently create press dies featuring low density and high compressive properties.

### BACKGROUND

High pressure presses with shaped dies have long been used to form sheet metals or other malleable sheet stock materials into final parts, such as body parts for motor vehicles and aircraft. A fixed-shape die, once formed, can be used for mass production of identical sheet metal parts that have complex shapes and curvatures, such as shapes that involve double curvatures.

The formation of a sizable die or pair of complementary dies from a sufficiently sturdy solid metal may be extremely costly and result in very heavy tooling that is difficult to change. The time and cost associated with creating large-format tooling, such as that for forming a door or quarter panel of an automotive body, makes short run tooling or designing by iterative refinements cumbersome and infeasible. Whereas traditional techniques such as CNC machining and electrical discharge machining (EDM) are usually applied to carve out a die from a solid block, metal additive manufacturing techniques may also be used to form press die tooling to some advantage but still require surface machining in many instances and yield a tool having considerable mass and significant cost. Thus, there remains a need for improvements in the field of producing large-format press dies for pressing and stamping of malleable sheet stocks.

### SUMMARY

The present teachings disclose processes and material compositions that enable large-format press dies to be produced by extrusion of a thermoplastic with enhanced mechanical characteristics. In accordance with some embodiments, a thermoplastic employing a mixture of fillers having different aspect ratios is shown to exhibit strength, modulus and other characteristics that render it suitable for making press dies. In accordance with some embodiments, the use of the extrudable filled thermoplastic extends an achievable linear dimension size, area or volume of a press die beyond the limitations of non-filled plastics. In some embodiments, the filled thermoplastic may be used as a feedstock material for an extrusion additive manufacturing process and, with proper design and slicing, allow for passages, interior frameworks, truss structures, internal voids or inclusions that lighten the die without undermining strength.

### BRIEF DESCRIPTION OF THE DRAWINGS

Various exemplary embodiments are illustrated by way of example, and not by way of limitation, in the figures of the accompanying drawings, in which like reference numerals refer to similar elements and in which:

FIG. 1 is a pictorial overview of an additive manufacturing system within which a polymeric composite material, in accordance with embodiments of the present teachings, may be usefully applied as a feedstock;

FIG. 2 is a pictorial overview of an automated manufacturing system comprising multiple tool heads for use in conjunction with exemplary manufacturing processes in accordance with preferred embodiments of the present teachings;

FIG. 3 is a diagram of a direct pellet extruder within which a polymeric composite material, in accordance with embodiments of the present teachings, may be usefully applied as a feedstock;

FIG. 4 is a diagram of a filament-fed extruder within which a polymeric composite material, in accordance with embodiments of the present teachings, may be usefully applied as a feedstock;

FIGS. 5A-5C present a diagram of an overall process of preparing and using a polymeric composite material to produce a part formed in a sheet metal press processes in accordance with preferred embodiments of the present teachings; and

FIGS. 6A-6C is a conceptual sketch depicting possible distributions of multiple types of filler particles within a polymer matrix.

### DETAILED DESCRIPTION

The following detailed description explains the preparation of a variety of polymeric composite materials according to the present teachings and then describes how to apply composite material as a feedstock an additive manufacturing process to, in turn, produce durable press die tooling for forming materials such as sheets of aluminum, stainless steel or soft iron. As will be shown, the particular novel composition of polymer matrix and a mixture of fillers having the prescribed attributes greatly facilitates the use of additive and subtractive processes in forming cost-effective and rapidly implemented forming tools which exhibit favorable physical properties such as strength, stiffness and durability.

In the following description, for the purposes of explanation, numerous specific details are set forth in order to provide a thorough understanding of illustrative and preferred embodiments of the invention. It is apparent, however, that some embodiments may be practiced without these specific details or with alternative, equivalent arrangements. In some instances, more common structures and devices are excluded from view or shown in block diagram form in order to avoid unnecessarily obscuring components that are more essential for illustrating embodiments of the invention and its operating principles.

At the outset, it is important establish that, unless the context indicates otherwise, the following terms shall have the following meaning as used herein and shall be applicable to both singular and plural forms:

The terms “a,” “an,” “the,” “at least one,” and “one or more” are used interchangeably. Thus, for example, a high-performance composite composition containing “a” an amorphous polymer and a reinforcing fiber means that the composite composition may include “one or more” amorphous polymers and reinforcing fibers.

The terms “additive manufacturing”, “three-dimensional printing”, or “3D printing” refer to any process used to create a three-dimensional object in which successive layers of material are formed under computer control (e.g., electron beam melting (EBM), fused deposition modeling (FDM), direct pellet extrusion, ink jetting, laminated object manufacturing (LOM), selective laser sintering (SLS), and stereolithography (SL)).

The term “feedstock” refers to the form of a material that can be utilized in an additive manufacturing process (e.g., as a build material or soluble support). Non-limiting feedstock examples include, but are not limited to, pellets, powders, filaments, billets, liquids, sheets, shaped profiles, etc.

The term “melt processing technique” means a technique for applying thermal and mechanical energy to reshape, blend, mix, or otherwise reform a polymer or composition, such as compounding, extrusion, injection molding, blow molding, roto molding, or batch mixing. For the purpose of clarity, 3D printing processes that are useful in printing thermoplastic and elastomeric melt processable materials are examples of a melt processing technique.

The terms “polymer” and “polymeric” mean a molecule of high relative molecular mass, the structure of which essentially comprises repeating units, derived actually or conceptually from molecules of low relative molecular mass, covalently bonded together.

The term “amorphous polymeric matrix” generally means a polymer that has less than 50% crystallinity as measured by differential scanning calorimetry (DSC). In the context of the present teachings, it is preferred to use an amorphous polymeric matrix exhibiting a flexural modulus (as determined by ASTM D790) that is greater than 2,000 MPa.

The term “reinforcing fiber” means a plurality of fibers having an average diameter less than 20 microns and average aspect ratio (Fiber Length/Fiber Diameter) greater than 10.

The term “polymer composite” means a melt processible composition of an amorphous polymer matrix and a reinforcing fiber.

The terms “preferred” and “preferably” refer to embodiments that may afford certain benefits, under certain circumstances. Other embodiments, however, may also be preferred, under the same or other circumstances. Furthermore, the recitation of one or more preferred embodiments does not imply that other embodiments are not useful and is not intended to exclude other embodiments from the claimed scope.

The recitation of numerical ranges using endpoints includes all numbers subsumed within that range (e.g. 1 to 5 includes 1, 1.5, 3, 3.95, 4.2, 5, etc.) and any subset ranges encompassed within the range.

As used herein, the term ‘molten’ is loosely applied to any state of a material when it is heated or otherwise softened and is of sufficiently low viscosity to flow through a small nozzle under pressure. It is recognized that for some materials a more precise terminology, such as a ‘plastic’ or ‘amorphous’ state, may be more commonly used and the term ‘molten’ is intended to encompass these situations. When a material is said to be ‘molten’ herein it will generally be at a temperature substantially at or above its glass transition temperature, where applicable.

Polymeric composites have utility in many commercial applications, including what may be termed ‘additive manufacturing’ or ‘three-dimensional printing’ (3D printing.)

A polymeric material may generally be considered to be ‘3D printable’ if it exhibits several important attributes. A 3D printable feedstock is preferably a thermoplastic that can be softened or melted at elevated temperatures, extruded through a relatively small nozzle and then cooled to solidify without significant chemical or structural degradation. Because 3D printing involves building a solid object by successive addition of extruded polymer, a favorable feedstock material will also exhibit substantial cohesion between newly applied material and previously applied material. Another useful attribute in some contexts is the ability of the feedstock material to be supplied and handled in the form of a flexible or semi-rigid filament wound on reels as is used by many types of 3D printers, though certain other types of printers will accept bulk pellets as an alternative to filament. A few of the many other factors that influence suitability as a 3D printing feedstock relate to heat dissipation, avoidance of nozzle clogging and voids, and achieving isotropic material strength characteristics in the finished object.

‘3D-printable’ polymeric composites, typically comprising a thermoplastic binder and some proportion of a fibrous filler for added tensile and shear strength, have been developed to meet application needs in many industries. However, one industry need that has not yet been addressed is a 3D printable polymeric composite that can meet the performance requirements for tooling applications, specifically sheet metal tooling applications. Such tools or forms have a particular shape and a raw sheet metal piece is reshaped by being forced to conform to the shape of the tooling. Under substantial force to cause deformation, the sheet metal is bent or stretched to conform to the tooling and thereafter retains the shape imparted by the tooling. Sheet metal forms are commonly fabricated out of steel or aluminum. Steel and aluminum have extremely high stiffness and compressive properties as are required to forcefully and permanently bend, deform or stretch a sheet metal blank into a finished shape. Unfortunately, despite the availability of some techniques to produce 3D printed metal parts in general, doing so to create metal tools for sheet metal forming is difficult and often prohibitively expensive, especially for large workpiece sizes. Accordingly, a need is recognized for a cost-effective and readily 3D-printable polymeric composite material for creating this type of tooling.

Polymeric composites have found significant industrial utility in many markets and applications. However, the number of polymeric composites that can be effectively 3D printed is limited as a result of requirements that are specific to 3D printing methods (i.e., rheology, adhesion characteristics, particle size, shrinkage/warpage, etc.). According to the teachings set forth herein, polymeric composites have been formulated to be 3D printable and to possess superior properties that make them amenable for certain tooling applications. In one embodiment, high-performance composites introduced herein comprise an amorphous polymeric matrix, reinforcing fibers and preferably a lightweight filler. In one embodiment, composites formulated according to the present teachings exhibit a compressive modulus greater than 3500 MPa and a compressive strength greater than 70 MPa. The high-performance composites of this invention have utility in many applications, including but not limited to, additive manufacturing feedstocks (e.g., fused deposition modeling and direct pellet extrusion). In a preferred embodiment, the amorphous polymer matrix is polycarbonate (PC), polylactic acid (PLA) or polycycloolefin copolymer (COC). In a preferred embodiment, the reinforcing fiber is carbon or glass fiber. In various preferred embodiments, the lightweight filler comprises hollow glass microspheres.

Thermoplastic composites as described herein have application in 3D printable tooling, specifically, sheet metal tooling. Such applications require extreme resistance to permanent deformation under high-speed, high-force loads. If the tool does deform under load, it must be resilient enough such that it recovers to its original shape when the load is removed. The advantage of 3D printed tooling is that it simplifies tool design and prototyping and enables fast iteration of experimental runs. It is also well suited for small lot productions runs as the cost to create tooling in this manner is far lower than that for conventional metal forms.

The present disclosure describes high-performance polymeric composites comprising a substantially amorphous polymeric matrix, reinforcing fibers and optionally hollow glass microspheres.

A variety of amorphous polymers can be ‘melt processed’ (essentially by heating and thorough mixing) with reinforcing fibers to create a range of composites in accordance with the present teachings. Amorphous polymers for use in the conjunction with present teachings preferably exhibit a flexural modulus greater than 2000 MPa and a degree of crystallinity less than 50%. Non-limiting examples of amorphous polymers that can be used to make such a composition of matter include acrylonitrile-butadiene-styrene copolymers (ABS), polyacrylates, polymethacrylates, polyesters, polyvinylchloride (PVC), polycarbonates, polystyrenes, cycloolefin copolymers (COCs) or combinations thereof. Preferred amorphous polymers include polylactic acid, polycarbonate and polycycloolefin copolymers. Additives, such as those disclosed herein to impart other useful attributes, may optionally be included with the polymer composition as well.

Reinforcing fibers are melt processed into the amorphous polymeric matrix. The present teachings may be implemented using organic reinforcing fibers or inorganic reinforcing fibers. In accordance with preferred embodiments, the reinforcing fibers have an aspect ratio (length/diameter) of at least 10:1 on average. Non-limiting examples of fibers that may be suitable include carbon fiber, basalt fiber, glass fiber, wollastonite, cellulosic fiber, carbon nanotubes and graphene. Preferred reinforcing fibers are glass fiber and carbon fiber. In one embodiment, the reinforcing fiber comprises between 1 and 50% of the polymeric composite composition. In a preferred embodiment, the reinforcing fiber comprises between 5 and 30% of the composite composition. In a most preferred embodiment, the reinforcing fiber comprises between 10-25% of the composite composition.

In accordance with some compositions made in accordance with the present teachings, the polymeric composite comprises a lightweight filler. Lightweight fillers useful in applying the present teachings are those that can survive the aforementioned melt processing. Non-limiting examples of lightweight fillers useful in implementing variations within the present teachings include hollow glass microspheres, polymeric microspheres, cenospheres, perlite and pumice. Preferred lightweight fillers are hollow glass microspheres with crush strengths greater than 10,000 psi, such as the IM30K hollow glass microspheres commercially available from 3M Company (St. Paul, Minn.). In one embodiment, the lightweight filler comprises between 1 and 30 wt % of the polymeric composite. In a preferred embodiment, the lightweight filler comprises between 5 to 20 wt % of the polymeric composite. In a most preferred embodiment, the lightweight filler comprises between 5-15 wt % of the polymeric composite.

In another embodiment, additional fillers may be added to impart certain performance attributes to the composite material, such as flexural modulus and strength. Non-limiting examples of fillers include mineral and organic fillers including carbonates, silicates, talc, mica, wollastonite, clay, silica, alumina, carbon black, carbon nanotubes, graphite, graphene, solid glass microspheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material.

The present teachings set forth a polymer composite comprising a novel combination of types of fillers having substantially diverse aspect ratios and maximum dimensions. In accordance with a preferred embodiment of the present teachings, a polymer composite combines both rigid linear fibers and rigid spherical fillers in a polymer to achieve characteristics that favor a specific application, such as creating 3D printed tooling for sheet metal forming presses. The rigid linear fibers may have length-to-width ratios of 10:1 or greater whereas the spherical fillers inherently feature approximately uniform dimension in all directions. The rigid linear fibers may have lengths of, for example, 6 mm and diameters of less than 8 microns whereas the spheres may have an average diameter of, for example, 18 microns.

The mixture of fillers having such diverse morphologies leads to unobvious advantages in various attributes that result from the interaction of the two fillers and go beyond just the superposition of their respective effects. It is contemplated that other combinations of fillers having substantially diverse morphologies may exhibit a similar interaction and improve the physical and mechanical properties of an amorphous polymer, especially in pursuit of the aforementioned feedstock characteristics that make the polymer suited for forming high compressive strength tooling by 3D printing. In accordance with preferred embodiments, the aspect ratios of fillers preferably differ by at least a factor of two, but factors of five, ten or greater are considered preferable. For example, in conjunction with a spherical filler having an aspect ratio of 1:1, a second filler may comprise elongated rigid filaments that have an aspect ratio of 5:1. In this instance, the aspect ratios differ by a factor of five.

TABLE 1 sets forth a complement of specific polymers, reinforcing fibers and lightweight fillers that have been demonstrated to achieve advantages according to the present teachings and principles. It should be underscored that these enumerated species are not to be considered as limiting the scope of the claimed invention.

TABLE 1
MATERIALS

| Material | Description & Supplier |
|---|---|
| Amorphous | Topas 6017S-04, polycycloolefin copolymer, |
| Polymer 1 | commercially available from Polyplastics USA |
| (AP1) | (Farmington Hills, MI) |
| Amorphous | Ingeo 4043D, polylactic acid, commercial available |
| Polymer 2 | from Natureworks LLC (Minneapolis, MN) |
| (AP2) | |
| Reinforcing | Zoltek PX35CA0250-55 carbon fiber, commercially |
| Fiber 1 | available from Zoltek, Inc. (Bridgerton, MO) |
| (RF1) | |
| Lightweight | Hollow glass microspheres, IM30K, commercially |
| Filler 1 | available from 3M Company (St. Paul, MN) |
| (LW1) | |

Various formulations of a polymeric composite materials, suitable for use as described herein, may be prepared using procedures and equipment that have been utilized in reduction to practice as outlined below. However, neither the present teachings nor the claimed matter should be construed to be limited in any respect by the complement of equipment, parameters and procedural steps set forth below.

To prepare the material samples, and obtain the data shown in TABLE 2 below, the following procedures were performed: Each of Samples 1-6 was prepared according to the weight ratios in TABLE 2. Samples 1-11 were separately, gravimetrically fed into a 27 mm twin screw extruder (52:1 L:D, commercially available from Entek Extruders of Lebanon, Oreg. as Model QC³. Compounding was completed using the following conditions: For Samples 1-6, the throat was at 100 C and barrels 2-14 and the die were at 220 C. The screw speed was 300 rpm and the output was 10 Kg/hr. For formulations 7-11, the throat was at 100 C and barrels 2-14 and the die were at 180 C. The screw speed was 300 rpm and the output was 10 Kg/hr. For Examples 1-11, The reinforcing fiber and lightweight fillers were separately fed downstream in a side stuffer in zone 5. The melt was extruded through a 3-strand die (3 mm diameter), conveyed onto a continuous cooling belt and pelletized into 3 mm×2 mm pellets. The subsequent pellets were injection molded using an ASTM tool and an Arburg 40-ton press. The barrel temperatures were 220 C for Examples 1-6 and 200 C for Examples 7-11. The resulting specimens were characterized for compression properties following ASTM 1621 and specific gravity following Archimedes Method.

TABLE 2
EXPERIMENTAL MIXTURES AND ATTRIBUTES

| | AP 1 | AP 2 | RF 1 | LW 1 | CS | CM | SG |
|---|---|---|---|---|---|---|---|
| Mixture | (wt %) | (wt %) | (wt %) | (wt %) | (Mpa) | (Mpa) | (g/cm³) |
| 1 | 90 | — | 10 | — | 121 | 3560 | 1.07 |
| 2 | 85 | — | 15 | — | 117 | 3950 | 1.09 |
| 3 | 80 | — | 20 | — | 136 | 4800 | 1.11 |
| 4 | 80 | — | 15 | 5 | 109 | 4370 | 1.09 |
| 5 | 75 | — | 15 | 10 | 117 | 4590 | 1.09 |
| 6 | 65 | — | 15 | 20 | 126 | 4660 | 1.05 |
| 7 | — | 85 | 15 | — | 100 | 5930 | 1.31 |
| 8 | — | 75 | 25 | — | 103 | 6830 | 1.35 |
| 9 | — | 80 | 15 | 5 | 101 | 4740 | 1.26 |
| 10 | — | 75 | 15 | 10 | 104 | 5230 | 1.23 |
| 11 | — | 65 | 15 | 20 | 110 | 5830 | 1.17 |

In TABLE 2, the column labeled ‘Mixture’ is simply an index by which to reference the samples prepared with different amorphous polymers and admixture ingredients that were listed in TABLE 1. The next four columns describe the weight percentages of the polymer matrix and filler materials. The final three columns refer to empirically measured physical properties of the respective mixtures, namely the compressive strength (CS), the compressive modulus (CM) and the specific gravity (SG).

One pattern apparent in TABLE 2 is observed by comparing Mixture 5 to Mixture 2. These represent a consistent proportioning of reinforcing fiber at 15% by weight, yet replacing some of the polymer with 10 wt % of hollow glass microspheres. In the responsive attributes, the compressive strength and specific gravity essentially remain unchanged, yet the compressive modulus is notably increased by about 16%.

Another pattern evident in TABLE2 comes from comparing Mixture 11 to Mixture 8 wherein compressive qualities are similarly increased upon addition of the specified of hollow glass microspheres as the lightweight filler.

Further, in reviewing the trends along mixtures 4-5-6 and 9-10-11 in TABLE 2, wherein the proportion of the spherical filler particles is successively increased, both compressive strength and compressive modulus appear to generally increase as a function of adding low aspect ratio filler material, even as the overall density of the material is reduced. In other words, it is possible to reduce consumption of the amorphous polymer by trading some volume with the spherical particles of the lightweight filler, achieving acceptable strength and stiffness but without also undermining extrudability characteristics as may be the case using only the fibrous filler to replace the polymer.

It should be reiterated that compressive strength and compressive modulus are not the only important response variables when the material is to be applied as a feedstock for additive manufacturing as taught herein. Some tradeoffs of strength and stiffness may be acceptable in favor of enhanced ease of additive manufacture and physical attributes of the object so formed. Some of these attributes may be difficult to quantify. Therefore, some example mixtures shown in TABLE 2, as well as other proportions and other ingredients beyond those listed, may be preferable in a given manufacturing context for reasons that are not evident from just the compressive strength and modulus data alone. Although Mixture 3 indicates that it may be possible to achieve even higher strength and rigidity by the addition of reinforcing fibers alone, other attributes—related to ease of 3D printing, loss of resiliency, lubricity and machinability—may be impacted by adopting this mixture. An exchange of strength and stiffness to yield a better feedstock for additive manufacturing may be well justified given that additive manufacturing enables tooling designs that include interior voids, trabecular structures, ‘where-needed’ interior supports and the like which dramatically improve build times and reduce tool costs and material consumption.

Some important attributes of a finished object formed from the composite are affected by the proportions among the polymer matrix, the substantially elongated fillers and the substantially round fillers. These include, for example, compressive modulus when formed, tensile and compressive strength, resiliency after each load cycle, thermal coefficient of expansion (TCE), surface lubricity, ease of machining, surface durability and isotropic strength characteristics.

Yet other important attributes relate to facilitating 3D printing processes, some of which are different from or go beyond the material requirements in other applications, such as conventional machining or injection molding. Where a filament-fed extruder is used, some crucial properties include the ability to extrude the material into a durable filament for use as feedstock. Where DPE is used, certain qualities may promote the ability to be formed into pellets and to feed reliably into a DPE head. For both extruder types, the extruded material should exhibit good cohesion among printed layers and be stable at extruder temperatures, resistant to nozzle clogging, and able to preserve homogeneity of filler concentrations while going through melting, extrusion, deposition and cooling.

It is postulated that excessive proportions of either type of the fillers described above could be detrimental. A high concentration of elongated (high aspect ratio) or fibrous filler particles may detract from extrudability and inter-layer adhesion during additive manufacturing, as well as finished-part machinability and lubricity. On the other hand, a high concentration of spherical (low aspect ratio) particles, especially if homogeneity is not achieved, can lead to localized brittleness and ‘chip outs’ in the part surface during machining or during cycles of use. The use of spherical additive alone also does not reduce ‘cold flow’ nor improve the tensile or flexural strength of the composite material to the extent that fibers do. The finished part design may well require some members of the part to tolerate tensile and flexural forces with resiliency.

Aside from these concerns with using solely one or the other filler type, a rationale is contemplated for using both types in complement to achieve better overall attributes of the polymeric composite material.

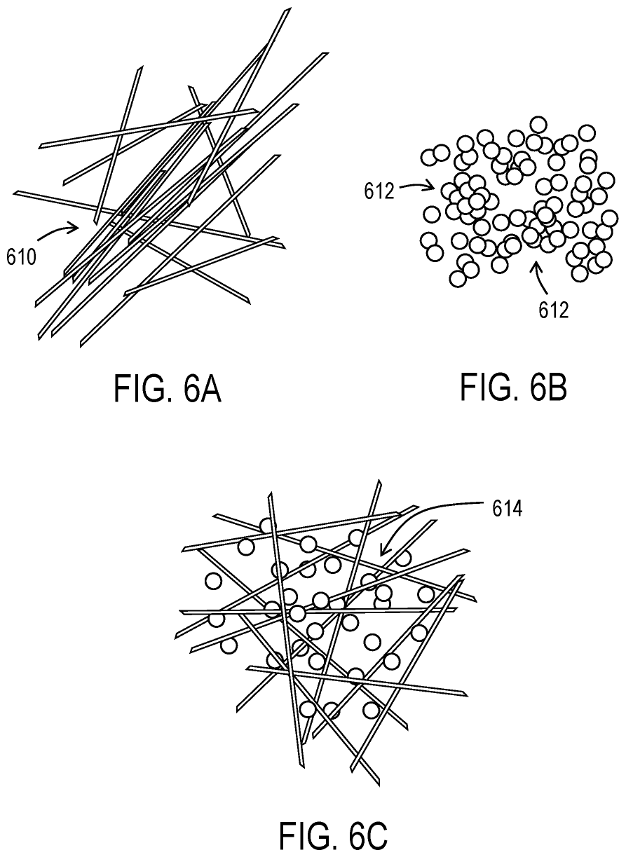

FIGS. 6A-6C provide visualizations of fillers distributed within a matrix, such as within a polymer, to explain a manner in which a combination of fillers having diverse aspect ratios may complement one another and mitigate some issues exhibited when using only one or the other. In all of these sketches (not drawn to scale), the fillers shown are presumed to be immersed in a polymeric matrix, substantially occupying all of the interstitial volume not occupied by the fillers, but the polymer itself is not shown or is considered to be invisible. Advantages are empirically realized by the present teachings, but the depiction of FIGS. 6A-6C are not intended to bind the claimed invention to a specific and confirmed theory of operation but rather to set forth a conceptual explanation as to how a diversity of aspect ratios might interplay to provide the observed characteristics or advantages.

FIG. 6A shows the presence of linear filler particles having a high aspect ratio. FIG. 6A depicts a situation wherein only linear filler materials, such as reinforcing fibers, are present to improve strength characteristics. These may be comparatively rigid and straight as shown or may be somewhat flexible or arcuate over much longer lengths. FIG. 6A reflects that, while there is generally a scattering of particle orientations and proximities, there may also be localized clustering among similarly aligned particles. This effect can be initially minimized by thorough mixing and shear agitation during compounding but some alignment and clumping may redevelop when a melt containing the fibers is forced through a tube or orifice, such as when the melt is extruded into a filamentous feedstock or is extruded from the nozzle in a DPE system. In the course of melting and reflowing of a composite material, elongated fibers may come into alignment and proximity as shown and the resulting cluster 610, once formed, may be energetically favorable or difficult to disrupt under random, mild shear conditions. On a macroscopic scale within the bulk material, some consequences of this coalescence may be areas of brittleness or directional variations in strength and stiffness, higher filler content to achieve a given overall strength and increased likelihood of clogging when the composite is forced through a narrow passage such as the extruder nozzle of a 3D printer. In the latter instance, an incompressible tight cluster is potentially more problematic than a tangle of randomly oriented fibers that can nevertheless change conformations and accommodate flow.

FIG. 6B depicts an alternative situation wherein only more-or-less spherical filler materials, such as hollow glass beads, have been added. These tend to improve compressive strength and various other qualities. Especially if hollow spheres are used, this type of filler can also lower the density of the composite material. The beads are preferably distributed in a homogenous fashion but, in reality, may drift into arrangement while the matrix is substantially ‘molten’ and coalesce into clusters 612 resembling close-packed hexagonal arrays. In particular, when using very uniform spheres in an environment which offers some mobility within the amorphous polymer matrix, it is possible for spheres to settle into close-packed arrays. FIG. 6B also demonstrates that spherical fillers may fail to disperse uniformly during original melt processing into the polymer matrix or may coalesce into localized clusters during later melt and extrusion processes.

As with the elongated particles of FIG. 6A, these localized clusters may be unlikely to disperse once formed. Clusters of particles that are spherical (or which otherwise have an aspect ratio nearing unity) lead to similar problems with inhomogeneous material quality. This phenomenon renders the filler less efficient and also locally rarifies the polymer matrix to create small domains within the composite that have behave quite differently than the bulk material at large.

FIG. 6C shows the presence of two fillers having significantly different shapes and aspect ratios, in this example, both elongated fibers and comparatively small spheres. FIG. 6C depicts a postulated phenomenon wherein the presence of interstitial spheres interferes with the tendency of the elongated fibers to align and coalesce. (See, for example, the vicinity indicated by reference number 614.) Bringing two fibers into parallel and proximity along the majority of their overlap length would require displacing any interstitial spheres and fibers that happen to be trapped between them. Likewise, the presence of elongated fibers tends to disrupt the formation of organized clusters of spheres. At the very least, it may be observed that a stable, regular arrangement comprising both elongated fibers and spheres (if there were one) is unlikely to spontaneously form and cause its own problems. As both fillers impart desirable changes in strength, modulus or other characteristics and yet dilute the concentrations of one another, the incidence of like-particle clustering is far reduced while achieving comparable or even improved strength and modulus characteristics and, moreover, providing additional benefits in terms of, for example, flow and machinability characteristics during additive/subtractive manufacturing.

In addition to the principal constituents mentioned above, various polymeric composite compositions according to the present teachings can also employ a variety of additives that can impart certain attributes and functionality to the resulting polymeric composite. Non-limiting examples of suitable additives include antioxidants, light stabilizers, fibers, blowing agents, foaming additives, anti-blocking agents, heat reflective materials, heat stabilizers, impact modifiers, biocides, antimicrobial additives, compatibilizers, plasticizers, tackifiers, processing aids, lubricants, coupling agents, thermal conductors, electrical conductors, catalysts, flame retardants, oxygen scavengers, fluorescent tags, inert fillers, minerals, and colorants. Additives may be incorporated into a polymeric composite polymer composition as a powder, liquid, pellet, granule, or in any other extrudable form.

Having described various polymeric composite materials as examples that embody the present teachings and principles, it is now appropriate to describe an example of manufacturing contexts and processes that influence the formulation of the composite and culminate in the construction of strong, durable components. A clear understanding of the equipment and processing steps affords a better appreciation for how the attributes of the feedstock material are crafted to support the overall production of tooling in this manner.

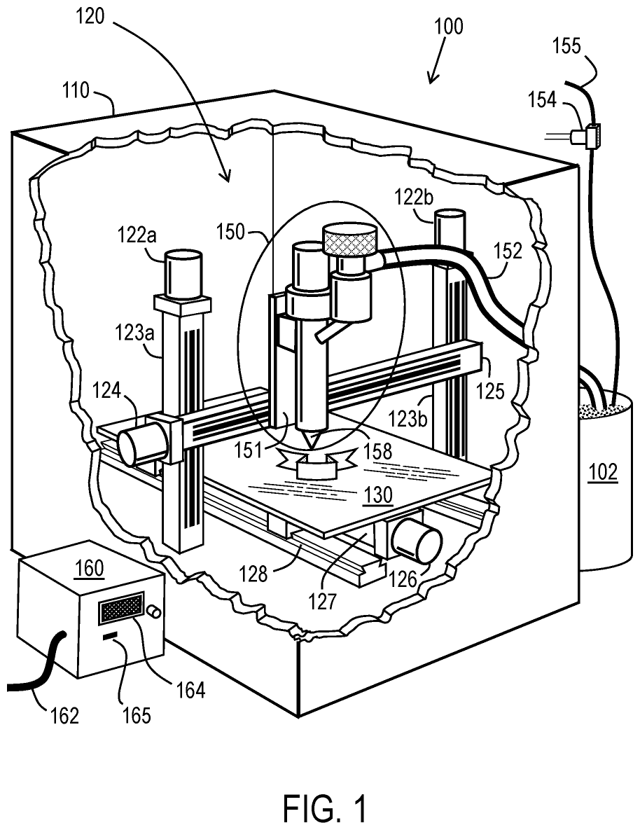

FIG. 1 depicts a representative additive manufacturing system 100 which may advantageously utilize, as input feedstock, a polymeric composite material formulated according the present teachings. System 100 is shown to comprise a motor-driven multi-axis motion control system 120 which controllably moves one or more tool heads, such as extruder head 150, relative to build plate 130. Build plate 130 may refer to either a direct surface for initiating additive builds or to a plate topped with an intermediary sheet of material or chemical coating. Accordingly, build plate 130 may also be referred to herein as a ‘build surface’ especially in reference to the topmost surface of the build plate plus any intermediary materials placed on top of it. The motion control componentry, combined with extruder head 150, constitute an additive manufacturing system and more particularly a form of 3D printer. Multi-axis motion control system 120 as shown creates movement along three orthogonal axes in an arrangement known as a Cartesian coordinate system wherein any point within the build space is referenced by a unique triplet of scalar values corresponding to displacement along three mutually orthogonal axes. Other coordinate schemes may be used to specify locations within the ‘build space’ of the system.

Extruder head 150 is shown to be attached to a carriage 151 that is controllably moved along the long axis of transverse beam 125 by the rotation of the shaft of an X-axis motor 124. Typically, beam 125 will comprise one or more linear bearings facilitating the smooth movement of carriage 151 parallel to the long axis of beam 125. Furthermore, beam 125 may house a lead screw (not distinctly visible in the diagram) which is coupled to carriage 151 by a precision nut, fixed within the beam 125 by rotary and thrust bearings and coupled to the shaft of X-axis motor 124. The rotation of the shaft of X-axis motor 124 may rotate the lead screw which, in turn, will cause carriage 151 to move closer to or further away from motor 124 in a controlled manner. X-axis motor 124 is often a stepping motor but may also be an AC or DC servo motor with a shaft position encoder and/or tachometer operating in a closed-loop control mode to facilitate moving to very precise positions. Many such arrangements of motors, lead screws, bearings and associated components are possible.

Whereas the arrangement of motor 124 and beam 125 accomplish controlled movement of the extruder head 150 in what may be termed the horizontal X-axis in the print-space coordinate system, motors 122A, 122B and their respective columns 123B, 123A may use a similar arrangement of linear guides, bearings and lead screws such that Z-axis motors 122A, 122B controllably move extruder head 150 in a vertical direction, that is, closer to or further away from build plate 130. More specifically, beam 125 may be attached to carriages (obscured in this view) that couple to lead screws within columns 123A and 123B. As Z-axis motors 122A and 122B rotate their respective lead screws in synchrony, the entirety of beam 125, X-axis motor 124 and extruder head 150 are caused to move upward or downward.

To accomplish yet another motion of build plate 130 relative to extrusion head 150, a third motor, which may be referred to as Y-axis motor 126 may act upon a lead screw 127 to which the build plate 130 is coupled. The rotation of the shaft of motor 126 controls the position of build plate 130. Build plate 130 may be supported by, and may slide or roll along, linear bearing rails such as rail 128.

It should be understood that the arrangement of motors, bearings and such depicted in FIG. 1 is merely one example of achieving controlled relative motion between extruder head 150 and build plate 130 such that an object is formed by the extrusion of materials through nozzle 158. Various other arrangements are common and equally suitable as an embodiment in which the present invention may be applied. For example, in some arrangements, the build plate may move in two horizontal axes while the extruder head may move only vertically. Alternatively, the build plate may only move vertically while an extruder head moves in two horizontal axes. In yet other arrangements, an extruder head may be coupled to a motor driven gantry that accomplishes motion in all three axes while the build plate remain stationary. The present invention is equally applicable to a wide variety of arrangements motion control arrangements independently including those just mentioned, as well as so-called ‘Core XY’, ‘H-bot’ and ‘delta’ arrangements. Robotic arms that accomplish angular motion at a series of pivoting joints may also be utilized.

In addition, it should be understood that, for simplicity, FIG. 1 excludes many fasteners, brackets, cables, cable guides, sensors and myriad other components that may be employed in the manufacture of such systems but which are not essential for explaining the principles of the present invention nor for describing the best mode thereof. Where linear guides and lead screws have been described, it should be understood that the present teachings are not limited to being applied to machines that use such mechanisms and that, for example, belt driven systems and gear driven systems are equally suitable for use and susceptible to the challenges that the present invention addresses.

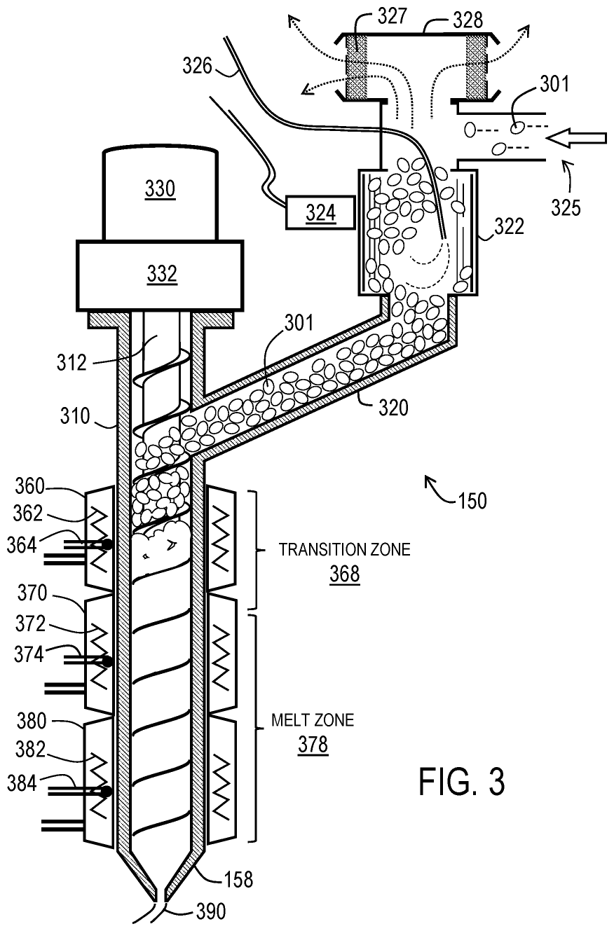

Extrusion head 150 is described in further detail below in conjunction with FIG. 3. In summary, the role of extrusion head 150 is to receive plastic in pellet form driven by bursts of air through a feed tube 152 and to ‘melt’ the plastic and drive it out of the end of nozzle 158 in a continuous stream. Typically, plastic pellets are stored in a large external pellet reservoir 102 and provided to the extruder head 150 in small increments as needed. A detector included with the extruder head 150 determines when additional pellets are needed and electrically controls the actuation of an air valve 154 which switches on a momentary burst of compressed air as provided by compressed air inlet 155.

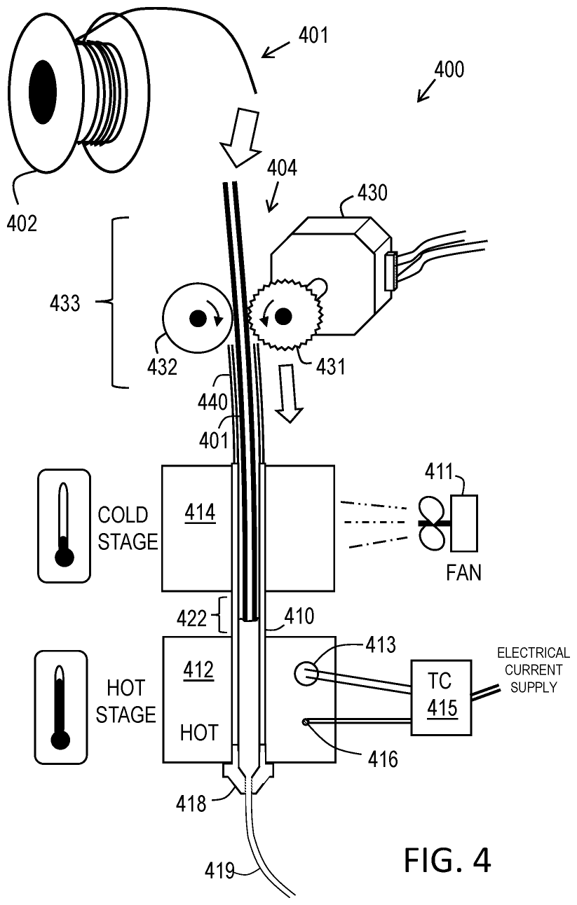

To orchestrate the moving parts of the system to form a three-dimensional solid object upon the build plate 130 from extruded materials emanating from the tip of nozzle 158, a control box 160 is provided with electronics, such as a microprocessor and motor drive circuitry, which is coupled to the X, Y and Z motors as has been described above, as well as to numerous sensors and heating elements in the system 120. Electronics within control box 160 also control an extruder motor, to be described below, whether the extrusion is of the direct pellet extrusion type (FIG. 3) or of the filament-fed type (FIG. 4.)

A wide variety of 3D printer control boards may be used. Some examples of suitable control electronics which may operate within control box 160 are the RAMBo™ control board manufactured by UltiMachine running Marlin firmware and so-called ‘Smoothie boards’ executing open-source Smoothieware firmware.

The primary role of such controller boards is to interpret sequential lists of positional commands, such as so-called G-code files and to output signals that drive the motors to implement the commanded movements. A G-code file, or the like, describing the coordinate movements necessary to form a particular object may be supplied to the controller through connection of the controller to a wired data communications network via, for example, TCP/IP communications through an Ethernet connection or via a wireless network connection, such as ‘WiFi’ or IEEE 802.11 connection. A G-code file (or a data file, such as a file in STL format from which a G-code file may be prepared) may also be supplied on a removable flash memory card, such as an SD card, which may be inserted at SD card slot 165 on control box 160.

For providing a human-accessible control interface, essentially all of the available control boards support an LCD display and user interface 164, as is shown to be a part of control box 160 in FIG. 1. The electrical power to drive the control box 160 and the motors sensors and heating elements of system 120 comes from a connection to electrical power lines 162.

Build plate 130 is preferably heated to a controlled temperature, most commonly using electrical resistance heating elements (not visible in the diagram) which may be mounted under the bed and thermally coupled thereto. For this purpose, it is common to use a heating mat made of high-temperature-rated silicone rubber that has electrically conductive paths embedded within and is adhered to the bottom of the build plate. A temperature sensor, such as a thermistor is typically included to provide feedback to a proportional-integral-derivative (PID) controller which maintains a set build plate temperature by controlling the application of heating current to the heating mat. Such elements for heating the build plate are commonplace and need not be further described here.

The temperature within enclosure 110 may be elevated over typical room ambient temperature by the addition of yet other heating elements (not shown) or simply by the heat incidentally dissipated from build plate 130. With a suitably insulated enclosure 110, heat from build plate 130 may be fully sufficient to heat the interior of the enclosure to beneficial levels by convection alone.

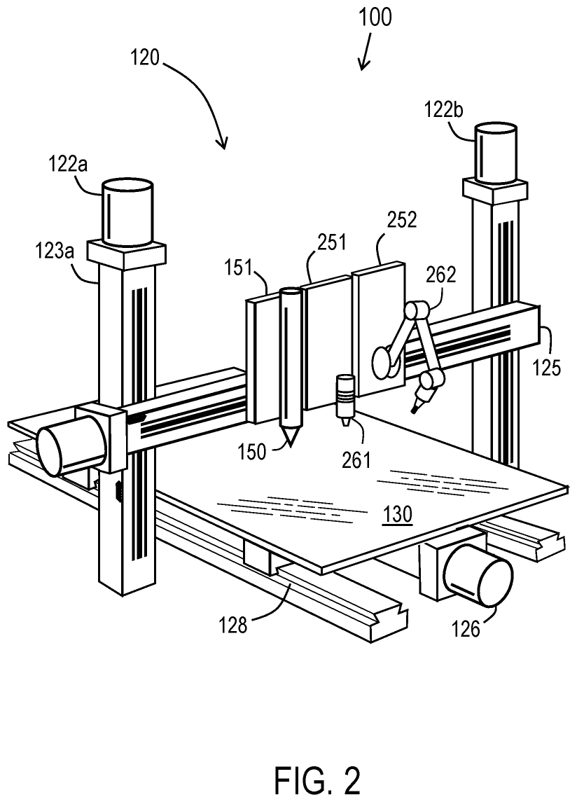

FIG. 2 presents a view of a manufacturing system, simplified in comparison with FIG. 1 by having the enclosure and other components removed from view to facilitate explanation of an example context wherein the present teachings may be advantageously applied. For convenience, system 100, labeled above as an ‘additive manufacturing system’, is preserved as such in FIG. 2 but it must be pointed out that system 100 has been augmented with other tool heads to constitute a system that is at least ‘additive’ in nature but may optionally apply other, possibly non-additive, processes as well. Henceforth, system 100 may be referred to as an instance of a more general ‘automated manufacturing system’ or a variation upon an ‘automated additive manufacturing system.’

Representative of newer systems, FIG. 2 depicts multiple tool head assemblies being coupled to transverse beam 125, one of those being direct pellet extrusion (DPE) head 150, by attachment to carrier 151, as was introduced in FIG. 1. Additionally, FIG. 2 shows a filament extruding head 261, attached to carrier 251, as another material-adding mechanism. Yet another tool head, multi-axis machining head 262, is coupled through carrier 252 to serve as a material-removal head operable within the same build space, and capable of acting upon the same constructed objects, as the two additive tool heads 150 and 261. Machining head 262 may have many axes of motion and may provide, at its distal end, a turning spindle or chuck that holds a cutting tool such as a drill bit, router bit or end mill. While three tool heads happen to be shown in FIG. 2—two additive and one subtractive—any number and mixture of tool heads may be realized, subject only to the practical limitations of the motion system and the space available. Further, although the three tool heads shown can be configured such that all three carriages 151, 251, 252 either travel together as driven by motor 124 or are combined into a single carriage, it is possible to build a system wherein each carrier moves independently by different mechanisms or at separate times by a shared mechanism. Through a mechanical or magnetic latch (not shown), each of carriers 151, 251, 252 might be selectively coupled and decoupled to a leadscrew or belt inside of transverse beam 125 at various times to either be driven along the transverse bar 125 or to remain ‘parked’ at either end of the travel range, allowing motor 124 to selectively drive only one of the carriers at any given time. Another alternative arrangement may involve having the tool heads travel along separate transverse beams or be carried as payloads at the distal ends of several independent robotic arms. A single robotic arm, typically having multiple linkages connected by articulating joints and capable of program-controlled movement to specific coordinates within the build space, may be equipped to latch onto a specific tool head and apply its action to an object being built.

The operation of both a direct pellet extruder and a filament-fed extruder are briefly described next with reference to how attributes of the composite material may affect suitability for these respective techniques, especially in cases where it may be of practical advantage to accommodate both types of extrusion using a single undifferentiated formulation.

Recently applied to serve as moving 3D printing heads, direct pellet extruder of the type shown in FIG. 3 offer many advantages over the types of extruders that accept fixed-diameter solid filament from a spool (to be described in FIG. 4). As a principal advantage in industrial printing, a pellet extruder can handle long, uninterrupted builds that would otherwise consume multiple conventional-size spools if one were using a filament extruder. For example, using a pellet extruder, a large 3D printed object with a mass of 100 Kg can be formed over a period of hours or days of continuous printing. In contrast, a filament-type extruder building the same object would require numerous interruptions for changing spools, which are commonly supplied in 1 Kg, 10 Kg or 25 Kg sizes. At each point during the build when an empty spool of material must be replaced, there is a risk of affecting the quality of the object and, in some cases, the interruption may even jeopardize an entire print process in which hours of print time and considerable expense have already been invested.

Another factor in favor of extruding directly from pellets is reduced cost. Plastics in pelletized form are considerably less costly than plastics that have already been formed into precise-diameter filament. Furthermore, because of the direct conversion from bulk pellets to molten form, a pellet extruder can print materials that are not amenable to being intermediately formed, stored and manipulated as solid filament, such as polypropylene, glass-filled polycarbonate, polyethylene and PVC. A direct pellet extruder can also support high throughput and large diameter discharge, such as through a 6 mm nozzle. This is considerably larger than the largest practical filament sizes of around 3 mm which often discharge through a nozzle opening of 1 mm or less. Thus, a direct pellet extruder can print large objects hundreds of times faster than a practical filament-supplied print head.

For explaining the general operating principles of direct pellet extrusion (DPE) head 150, FIG. 3 of the drawings depicts a typical design of a pellet extruder. FIG. 3 presents a desired or expected operation of such an extruder head, but it must be emphasized that, without the benefit of the present teachings, successful functioning may be hindered by undesirable effects as described herein. As introduced above, the role of pellet-type extruder head 150 is to convert solid pellets of plastic into a controlled stream of molten plastic and to deposit the plastic at specific locations to form an object on build plate.

In FIG. 3, extruder head 150 comprises lead screw 312 disposed within cylindrical barrel 310. Rotation of lead screw 312 by the action of a motor 330 through reduction gearbox 332 to achieve high torque at low controlled speeds, causes a general downward movement of plastic pellets 301 entering the barrel from pellet hopper 320. Barrel 310 is heated by a plurality of heating stages 360, 370 and 380 which are controlled to achieve a desired temperature profile along the length of the barrel. For example, as pelletized materials entering at the top of the barrel and are compressed and compelled down by the lead screw, it is desirable for an upper zone referred to as a ‘transition zone’ 368 to be set at 180 Celsius. Further down barrel 310, the materials may experience a temperature nearing ultimate melt temperature at 220 Celsius as they pass through a melt zone 378. These temperatures work well for ABS but may differ for other materials. Heating stages to accomplish this temperature profile may comprise electrically resistive heating elements that nestle against or encircle barrel 310 to conduct heat thereto. The uppermost heating stage 360 comprises a heating element 362 such as a resistive wire (nichrome) by which passing a controlled average current achieves a desired temperature of the barrel. A common heating tape or heating jacket is one example of a heater that may be applied.

Heating stage 360 also comprises a temperature sensing element 364, such as a thermocouple that provides actual temperature information to a control unit that gate the flow of electrical current to the heating element 362 to maintain a constant desired temperature. This temperature control function may be integrated into or collocated with other control electronic circuitry within control box 160, introduced earlier. Many of the commonly available motor control boards have integrated temperature controller capabilities but this may also be handled by separate, commonly available closed loop controllers.

Heating stages 370 and 380 operate similarly to stage 360, each having respective heating elements 372, 382 and temperature sensors 374, 384 to achieve independent localized temperature control along extruder barrel 310. It is common for each heating element 362, 372, 382 to have an output rating in the hundreds of watts.

The effects of the heat thus applied to barrel 310, along with the compaction and propulsion of material through the barrel by lead screw 312, are apparent in that loose pellets 301, which are depicted as loosely arranged and which tend to settle downward under gravity within pellet hopper 320, are contacted and driven downward by lead screw 312. As the pellets are driven downward and enter transition zone 368, the pellets begin to soften and flow into one another and any interstitial air starts to be driven out due to the rising pressure. As the softened materials move into the more elevated temperature of melt zone 368, the melted plastic becomes homogeneous and free of any voids or air bubbles. In moving downward through the barrel, the materials reach full temperature and are driven down into nozzle 158 and they can be ejected as a continuous bead in the form of an extruded output 390. Even though a continuous outflow can be maintained indefinitely as long as pellets are supplied, it should be noted that, in more typical builds, the expulsion of extruded material can also be abruptly halted and resumed by the control of extruder motor 330, which is within the realm of what is motion-controlled subject to the same G-code scripting just as the X-Y-Z motors. In other words, the extruder can produce continuous streams or short segments of discharged material as needed for a given build process. Control of extruder motor 330 in coordination with the motion effected by the motors 122, 124, 126, results in controlled amounts of material being deposited in specific locations and patterns to construct a three-dimensional solid object on build plate 130.

Pellets 301 are provided to extruder head 150 from a remote location at pellet inlet 325. As mentioned previously, a long pellet feed tube 152 may deliver air-borne pellets using blasts of compressed air. As a burst of air carries pellets into the extruder head 150, the pellets fall into a holding chamber 322 and the air that carried the pellets disperses upward through an air filter 328 which comprises a fine screen or filter medium 327, such as a fluted paper filter. Air filter 328 traps any pellets that are propelled upward by an incoming air blast and allows them to settle into chamber 322 when the blast subsides. Air filter 328, especially filter medium 327, also captures extraneous debris or powder that might arrive with a burst of pellets.

As pellets within feed hopper 320 are consumed by the extrusion process, being pulled into extruder barrel 310 by lead screw 312, pellets in holding chamber 322 drop into feed hopper 320 and the overall level of pellets in chamber 322 slowly diminishes. A pellet level sensor, such as a capacitive proximity sensor 324, detects the presence or absence of pellets above a given level in the holding chamber 322. When sensor 324 senses that the fill level of pellets within chamber 322 is below a threshold, it sends an electrical signal indicating that more pellets are needed and this signal (either directly or through a control circuit in control box 160) causes electrically-actuated air valve 145 (FIG. 1) to turn on for a time. This causes compressed air to enter the mouth of the feed tube 152 which is immersed in a reservoir of pellets. Pellets are entrained with the resulting air burst and carry pellets to the chamber 322 until sensor 324 determines that chamber 322 is again adequately filled. The frequency with which sensor 324 calls for a burst of pellets depends on the rate at which pellets are being consumed by the extruder. That, in turn, depends on printing speed and nozzle size. The automatic refilling mechanism just described seeks to ensure adequate pellet supply to the extruder over a wide range of consumption rates. To further ensure reliable feeding of pellets from holding chamber 322 into pellet hopper 320, a stream of compressed air is supplied through tube 326 to provide constant agitation of pellets inside holding chamber 322. This prevents the pellets from settling into a ‘bridge’ formation—that is to say, coming to rest such that multiple pellets crowd the opening of the hopper and mutually prevent one another from either dropping into the tube or moving out of the way. This agitation also seeks to prevent pellets from remaining in contact long enough to form adhesions, although the effectiveness drops rapidly with increased chamber temperature. To allow a human operator to visually monitor successful pellet feeding and replenishing, holding chamber 322 is preferably made of a transparent material.

To support successful operation of a direct pellet extruder as just described, a feedstock composite material must exhibit certain favorable characteristics, such as the ability to be rendered in the form of pellets, spheres or the like. It is highly desirable that pellets of a candidate composite material are light enough to be borne by air bursts and have little tendency to stick to one another or to get hung up in the pathway between the inlet 325 and the transition zone 368 at which the pellets are fully engaged and forcefully driven by extruder screw 312. Surface physics and glass transition dynamics may be important under some circumstances. Surface finish of pellets, such as concavities, flat surfaces and spurs may impact successful feeding, depending on other factors. Finally, some areas of tapering within the extruder, especially near the nozzle, may be prone to clogging as filler particles may become oriented and either coalesce into quasi-organized clumps or into tangles. Selection of fill material and size may affect how well a composite material prints using a DPE. In particular, as it relates to the present teachings, a mixture of filler materials having diverse shapes or aspects ratios may afford some improvement in one or more of these characteristics when a DPE is used.

FIG. 4 depicts a so-called filament extruder that is very common among desktop 3D printers but can also be applied as an alternative to direct pellet extrusion in large-scale 3D printing. FIG. 4 shows a typical filament extrusion arrangement 400 of the type that could fulfill the role of filament extruder head 261 introduced earlier. A thermoplastic with sufficient flexibility may be formed as a continuous strand of fixed-diameter filament 401 and wound upon a reel 402 for storage, for transport and as a source from which as the filament is steadily drawn as it is being consumed in a 3D printing process. Filament 401 is shown to fed into the input end 404 of a series of components that constitute filament extrusion arrangement 400. A key design feature of the most common types of filament extruders is that the filament itself serves as a piston to drive molten plastic through a heated passage and out through a nozzle under pressure. As part of this scheme, the inside diameter of the heated passage is only slightly larger than the diameter of filament 401. FIG. 4 shows a passage in the form of a tube 410 joining a heated block 412 and a cooling block 414. Depending on implementation, tube 410 may be a continuous tube or the like, or may be a concatenation of abutting tubular sections, often formed by threaded tubing sections meeting ends within threaded holes through blocks 412 and 414. Heated block 412 is typically provided with one or more electrical-resistance heating cartridges 413 and is maintained at a specific temperature by a thermostat or temperature controller 415 which monitors heating block temperature using a thermocouple or thermistor as a temperature sensing element 416 and controlling the electrical current delivered to heating cartridge 413. Heating block 412 reaches sufficient temperature to effectively melt or soften the thermoplastic material of the filament such that it can flow from nozzle 418 as extruded material 419. Furthermore, heating block 412 must receive enough heating power to maintain temperature, even as a mass of cooler filament constantly traveling down tube 410 must be raised to melt temperature for timely emission from nozzle 418.

A force for driving filament 401 into and through the passage 410 is provided by extruder drive motor 430 which turns a knurled or ribbed drive gear 431. Gear 431 firmly contacts filament 401 and the knurling or ribs provide traction, with a pinch roller 432 providing opposing force to help grip the filament. Drive motor 430 is typically a computer-controlled servo or stepping motor for providing precise filament advancement in synchrony with other movements of the extruder head relative to the build plate.

As the filament driven by extruder drive motor 430 is pushed within tube 410 towards heater block 414, a particular phenomenon occurs wherein the filament softens just enough to spread and form a perfect seal against the inner walls of tube 410. A localized rigidity gradient is formed within the material and forms a notably stable seal. Were any hotter, softer portion of the material to attempt to seep upward past the ‘seal’, the portion would immediately cool and become integral with the cooler, harder portions above.

In seeming contradiction to the goal of heating and extruding the filament, a cooling block 414 is shown to be thermally coupled to tube 418. Without the benefit of cooling block 414, heating block 412 might heat the entire length of tube 410, especially if the apparatus were to remain idle for a period of time. The uppermost end of tube 410 could then exceed the softening or glass transition temperature of the filament material, at which point the desired seal effect just described would be lost and molten material would exude over the top of the tube. Cooling block 414 is provided to assure that the entirety of tube 410 does not elevate to melt temperatures and, moreover, to control the location where the internal self-sealing phenomenon occurs. A transition region 422 generally designates a small section along tube 410 at which the temperature crosses over between the lower temperature of block 414 and the higher temp of block 412. The actual location of where the seal forms may fall somewhere within section 422 or may be slightly further within block 412 or within block 414, depending upon material flow rates, thermal conductivities, temperature settings, etc.

Selection of a thin-walled tube 410 can reduce the path for thermal conduction in the short segment between heating block 412 and cooling block 414, which reduces the thermal load on each of these members as they strive to maintain their respective temperatures.

Cooling block 414 is equipped to dissipate heat due to conduction or convection from nearby heating block 412. The most common technique is to provide cooling block with heat dissipating fins made from a highly thermally conduction material, such as aluminum, and blowing ambient room air over the fins using a small electric fan 411. Block 414 may alternatively be liquid cooled by circulating a coolant gas or liquid through passages in the block. This approach may be preferred where a heated build enclosure is in use and the nearby ambient temperatures would offer far less cooling efficiency.

In some equipment designs, the extruder motor drive 430 may physically located just above the cooling block 414 and heating block 412 and may be mounted (as upon carriage 251 in FIG. 2) to travel as a unit with these blocks. Alternatively, extruder drive assembly 433 may be located somewhat remotely from the moving blocks and nozzle and may remain stationary. To assure that thrust applied to filament 401 by extruder drive assembly 433 is transmitted to force filament 401 into passage 410 (instead of just enlarging a loop of filament spanning between the extruder drive assembly 433 and passage 410) an optional Bowden tube 440, which is laterally flexible but longitudinally rigid, may be attached as a feed tube between these members. Bowden tube 440 preferably has an inside diameter that is large enough to easily pass the filament. The inside diameter should also be less than twice the filament diameter to minimize play so that filament is more responsive as advancement and retraction motions are executed by motor 430.

To support successful operation of a filament extruder arrangement as just shown, the feedstock material, provided in the form of filament 401, needs to be capable of being formed into filament and then exhibit sufficient flexibility to be spooled onto reel 402. Temperature-related characteristics such as glass transition rheological properties and thermal stability may render some potential feed stock compositions more suitable than others for filament-fed 3D printing processes. An additional concern when considering filled thermoplastic composite materials is clogging of nozzles due to gathering and clumping of filler material. This is of particular concern if nozzle taper or other prevailing conditions encourage filler particles to align, gather or tangle to form a filler-enriched plug.

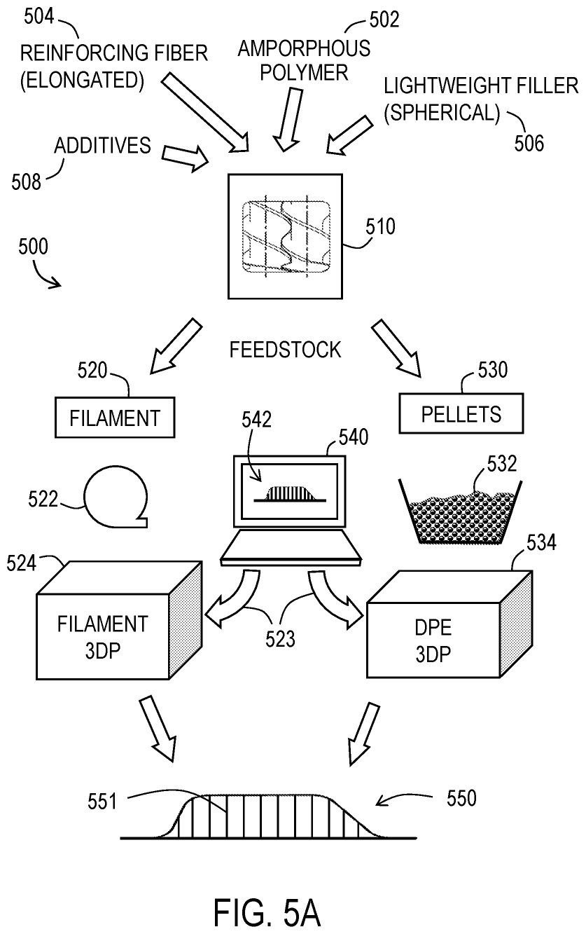

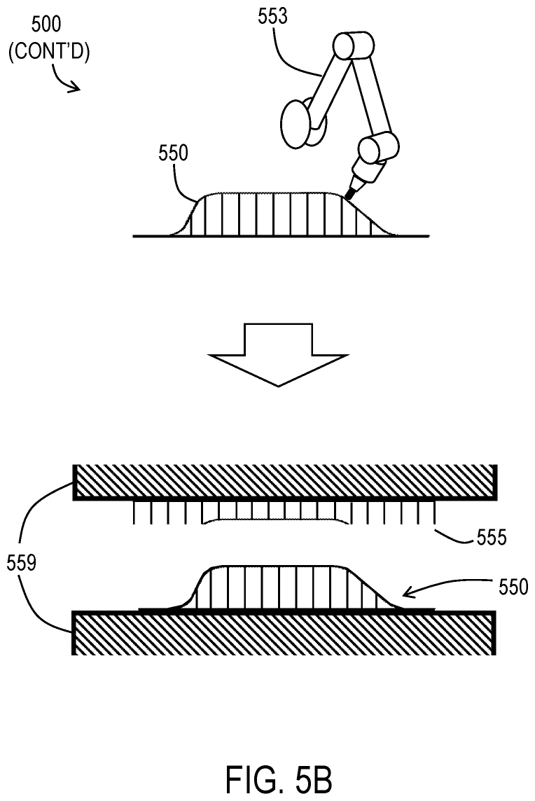

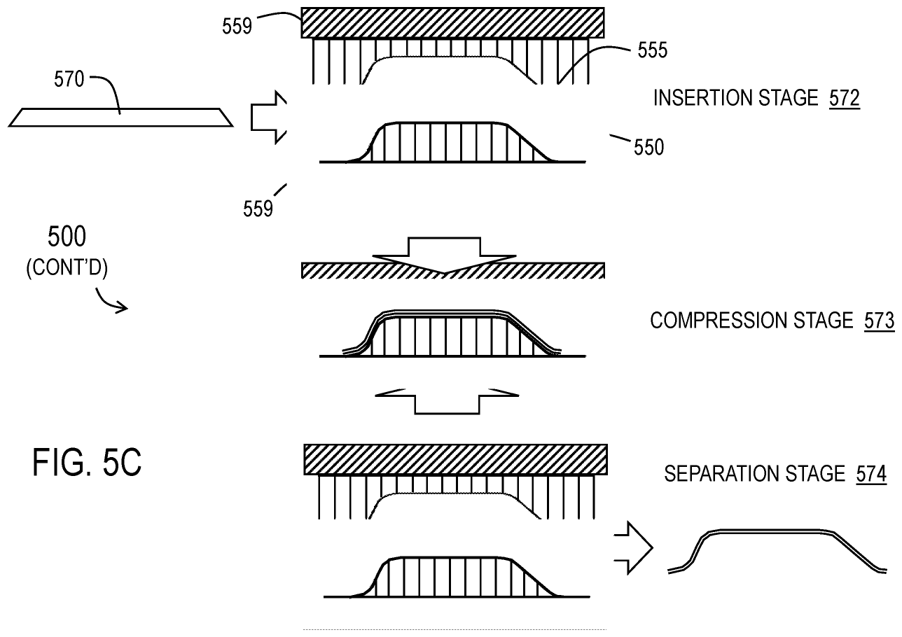

FIGS. 5A-5C pictorially describe a process 500 for producing sheet metal forming tools by using additive manufacturing as but one example environment wherein the present teachings may be usefully applied. In FIG. 5A, raw material components are depicted as feeding into a melt process 510 for mixing the components to yield a filled polymeric composite material for use as a 3D printing feedstock. These components comprise an amorphous polymer 502 as a principal binding matrix, a first filler having substantially elongated particles (exemplified by reinforcing fibers 504 which preferably have an aspect ratio (length-to-diameter) of greater than 10:1) and a lightweight second filler 506. Additives 508 may optionally be introduced into the mix to change certain properties of the composition.

In accordance with a preferred embodiment, lightweight filler 506 may comprise particles that, unlike filler 504, are not significantly elongated and may, in fact, be spherical. In particular, lightweight filler 506 may comprise hollow glass spheres to reduce density and provide significant compressive strength and other advantages to be described herein.

Melt process 510 combines these components into a homogenous composite material that may be drawn or extruded into a feedstock in the form of filament 520 or may be calendared, chopped, cast or otherwise pelletized into a feedstock in the form of pellets 530.

Filament 520 may then be provided, such as upon spool 522 to a filament-fed 3D printer 524, that is, one that uses a filament extrusion head similar to that shown in FIG. 4. A three-dimensional design 542, expressing the desired shape of a sheet metal forming tool 550, may be prepared at a computer workstation 540, converted into a sequence of motion commands 523 that are conveyed to printer 524. Using the composition prepared by melt process 510, printer 524 acts on instructions 523 and creates the required forming tool 550 which, by virtue of the present teachings, has mechanical characteristics that make it suitable for sheet metal forming operations.

Alternatively, the composite material in the form of pellets 530, may be provided in bulk form 532 and provided to pellet-fed 3D printer 534 which comprises a direct pellet extrusion head of the type depicted in FIG. 3. Operating upon sequential motion commands 533 from workstation 540 and utilizing the composition prepared by melt process 510, printer 534 may construct forming tool 550.

Regardless of which type of printer is used, the resulting printed forming tool 550 benefits from the unique ability of additive manufacturing to provide for internal supports 551 in the form of struts, walls, truss structures, waffled fills, interstitial voids and the like, as would be difficult or impossible to form by more traditional means. Large-format tools especially benefit from being additively produced to only place material where needed. At this stage, certain properties of the polymeric composite can facilitate or reduce the burden associated with some of this post-processing. For example, tooling for forming sheet metal into final part shape measuring 1 meter by 0.5 meter and having a relief depth of 0.25 meters may be quickly and efficiently produced from a composite material embodying the present teachings.

Preparing press die tooling by additive manufacturing of the recommended dual-filler composite offers many significant advantages. Large-format tooling can be fabricated relatively quickly and inexpensively compared to all-metal tooling, making even short-run tooling cost effective. Furthermore, because of the increased rigidity and compressive strength imparted by the dual fillers, deep excursion tooling including internal truss structures, struts and lightweighting interior voids are made possible using an extrudable thermoplastic matrix. This large-format tooling may be applied to general purpose flat press jaws and, due to the light weight compared to metal tooling, tool change outs may be carried out more readily and safely than with metal counterparts. In the context of using thermoplastic materials for creating press dies, large format may refer to die dimensions, raw material sheet dimensions or final part dimensions that exceed 0.25 square meters in surface area or have at least one dimension exceeding 0.50 meters. Alternatively, the term ‘large format’ may refer to die dimensions, raw material sheet dimensions or final part dimensions having at least one linear dimension that exceeds one or more values from the set consisting of 0.25 meters, 0.50 meters, 0.75 meters, 1 meter, 1.4 meters, 2.0 meters and 3.0 meters. Additionally or alternatively, the term ‘large format’ may refer to die dimensions, raw material sheet dimensions or final part dimensions wherein the area exceeds one or more values from the set consisting of 0.125 square meters, 0.25 square meters, 0.50 square meters, 0.75 square meters, 1 square meter, 1.4 square meters, 2.0 square meters, 4.0 square meters and 9.0 square meters.

Depth of impression made in the sheet metal may also distinguish ‘large format’ tooling. In proportion to the lateral dimensions discussed above, depth of impression may be 10% or greater, though even some shallow reliefs could be very demanding on tooling if there are significant localized slopes. In absolute measurements, a depth by which a press permanently deforms a flat sheet to form a large format part may be in ranges such as 0.1 meter or greater, 0.2 meter or greater, 0.3 meters or greater, 0.5 meters or greater. While some implementations have sought to use polymers as linings atop shaped metal dies, the present teachings recommend and enable the constructing of press dies completely by additive manufacturing using the particular multiple-filler thermoplastic composition, adapting generic flat press jaws to the desired die cavity shape. This ability for the additively formed tooling to be fully complete and self-contained may in some cases eliminate the need to prepare any part-specific or complementary metal tooling as backing behind the polymeric die face. This practice also facilitates changing out different tooling sets on a given multi-purpose press.

The relative proportions of the amorphous polymer 502, filler 504 and filler 506, along with possible additives 508, may be adjusted to improve the ability to machine, polish or otherwise prepare the surface of forming tool 550. For example, the addition of fillers that stiffen a polymer or alter the thermal conductivity can lead to cleaner, more precise cuts from milling bits with less stringing and collateral melting. However, excessive concentrations or inhomogeneous distribution of some fillers can lead to voids or ‘chip outs’ during machining that causes pits in the surface.

FIG. 5B represents the next step in an overall process to make and apply a polymer composition to the creation of sheet metal forming tools. After being built by the process of 3D printing, forming tool 550 may undergo some additional refinement by machining to exact dimensions, abrading, polishing, coating or otherwise preparing the surface of forming tool 550. Representative of machining to final surface contours, a robotic multi-axis machining head 553 is depicted as acting upon forming tool 550. In some implementations, this process may be carried out by tool head 262 as integrated into system 100.

FIG. 5B also shows a complementary forming tool 555 which may be designed and formed by the same process shown in FIG. 5A. Complementary forming tool 555 is generally designed to accommodate the shape of, and approximately parallel the same contours as, forming tool 550 but may require some departure from that shape as needed to force a sheet metal blank to form properly. In preparation for processing sheet metal blanks into formed shapes, forming tools 550 and 555 are attached to opposing jaws 559 of a press.

Even though complementary press dies 550 and 555 are shown for illustrative purposes, single-face press dies are equally possible that work in conjunction with rollers or in hydroforming processes. Depending on the design of the final part to be formed, some press dies may be designed to impart only singly curved bends, folds or curvatures and, even with multiple such turns on a single workpiece, if the bends, folds and curvatures do not intersect or overlap within the boundaries of the sheet being formed, there is minimal need to forcefully elongate parts of the sheet stock. In more demanding applications involving doubly curved surfaces, intersecting bends or deeper drawn portions, the press die may be designed to apply significant elongating forces to the sheet stock.

The action of the press with the 3D printed forming tools in place is depicted in FIG. 5C. A blank 570 of material to be formed may represent a sheet of stainless steel, soft steel, an aluminum alloy, plastic, leather, or other material that is to be formed using the shaped tools. Of course, the present teachings are not limited to only being applied where sheet stock is to be formed. It is contemplated that forming tools constructed as set forth herein may also be used in cases where a non-planar or partially preformed blank is to be reshaped under pressure or force.

Blank 570 is inserted (stage 572) between the jaws of the press and, in particular, between opposing forming tools 550 and 555 formed in accordance with various aspects of the present teachings.

Compression stage 573 corresponds to pressing the jaws 559 together, trapping blank 570 therebetween and applying sufficient force to displace, deform or reshape the blank according to the design of forming tools 550, 555. In some applications, the compression step may accompanied by heating the blank, the forming tools, or both. The compression process may also include the application of a vacuum, a lubricant or a cover gas. In large presses, the overall force applied to the jaws may be several tons and the overall cycle time may range from fractions of a second to several minutes, depending on the material being formed. In some processes, blank 570 may initially be inserted in a somewhat pliable form but then may undergo hardening, cooling, drying, phase change or a chemical reaction, such as polymerization, to become more permanently shaped in compliance with the cavity defined by the forming tools. After the necessary forming cycle is completed, separation stage 574 is performed wherein jaws 559 are drawn apart and the formed part is removed from the press.

The present teachings as to a polymeric composite and a 3D printing process for creating polymer forming tools is not constrained to the present example involving a sheet metal blank, though this utilization is considered to be particularly challenging and the present teachings are considered particularly advantageous in addressing those challenges. The present teachings may be applicable to vacuum forming and lay up forms as well, depending on compatibility of materials and solvents, where used.

Throughout stages 572-574, compressive strength and modulus, lubricity and abrasion resistance may be at least some useful qualities in considering a material from which to make the tools and in considering the proportions of amorphous polymer, elongated and non-elongated fillers and optional additives from which to make a polymeric composite suitable for the forming tools.

In the preceding description, various exemplary embodiments have been described with reference to the accompanying drawings. It will be evident, however, that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A process for producing a press die, shaped according to a digital data model representing an outer shape of the die, comprising:
additively manufacturing the press die from a polymeric feedstock composition by cumulatively extruding the feedstock composition to conform to an outer shape according to the digital data model;
wherein the feedstock composition comprises:
an amorphous thermoplastic;
a first filler material, distributed in the amorphous thermoplastic, comprising particles having a first average dimensional aspect ratio; and
a second filler material, distributed in the amorphous thermoplastic, comprising particles having a second average dimensional aspect ratio differing from the first average dimensional aspect ratio by at least a factor of two.

2. The process of claim 1 wherein the first filler material comprises elongated particles having a first aspect average dimensional aspect ratio greater than 10:1.

3. The process of claim 2 wherein the first filler material comprises elongated fiber particles made of at least one of the group consisting of: glass, carbon, cellulose, mineral, and polymer fibers.

4. The process of claim 2 wherein the first filler material comprises substantially rigid fibers.

5. The process of claim 1 wherein the second filler material comprises substantially round particles having a second average dimensional aspect ratio of approximately 1:1.

6. The process of claim 2 wherein the second filler material comprises substantially round particles having a second average dimensional aspect ratio of approximately 1:1.

7. The process of claim 6 wherein the second filler material comprises hollow spheres.

8. The process of claim 6 wherein the second filler material is made of at least one material from the group consisting of: glass microspheres, pumice, expanded ash, cenospheres, and polymeric microspheres.

9. The process of claim 1 wherein the amorphous thermoplastic comprises one or more species chosen from the group consisting of: acrylonitrile-butadiene-styrene copolymers (ABS), polyacrylates, polymethacrylates, polyesters, polyvinylchloride (PVC), polycarbonates, polystyrenes, cycloolefin copolymers (COCs), polylactic acid, polycarbonate, and polycycloolefin copolymers.

10. The process of claim 1 wherein the weight proportion of the first filler material is greater than or equal to 10% and the weight proportion of the second filler material is greater than or equal to 5%.

11. The process of claim 1 wherein the composition exhibits a compressive strength greater than 100 MPa.

12. The process of claim 1 wherein the composition exhibits a compressive strength greater than 70 MPa.

13. The process of claim 1 wherein the composition comprises a first weight percentage of the first filler material and exhibits greater compressive strength than the amorphous thermoplastic alone and wherein the specific gravity of the composition is lower than that of an alternative composition comprising only the amorphous thermoplastic and the first weight percentage of the first filler material.

14. The process of claim 1 wherein the composition comprises a first weight percentage of the first filler material and exhibits greater compressive modulus than the amorphous thermoplastic alone and wherein the specific gravity of the composition is lower than that of an alternative composition comprising only the amorphous thermoplastic and the first weight percentage of the first filler material.

15. The process of claim 1 wherein the composition comprises the amorphous polymer and a fixed first weight percentage of the first filler material and a variable second weight percentage of the second filler material, and wherein increasing the second weight percentage of the second filler material increases at least one of the compressive strength or the compressive modulus of the composition.

16. The process of claim 1 further comprising:
computing at least one set of tool path instructions for directing an additive manufacturing system to extrude the polymeric feedstock composition, the tool path instructions comprising at least one set of instructions for forming a perimeter that conforms to the outer shape and at least one set of instructions for forming at least one unfilled void within an enclosed volume defined by the digital data model.

17. The process of claim 1 further comprising:
computing at least one set of tool path instructions for directing an additive manufacturing system to extrude the polymeric feedstock at specific locations, the tool path instructions comprising at least one first set of instructions for forming a die face that conforms to the outer shape defined by the digital data model.

18. The process of claim 17 wherein the tool path instructions further comprise at least one second set of instructions for forming at least one unfilled passage disposed between the die face and a surface of the die that contacts a jaw of a press.

19. The process of claim 1 wherein at least one linear dimension of the die is greater than 0.5 meters.

20. A press die for forming a malleable material into a specified shape, the press die comprising:
a first surface being shaped such that pressing the malleable material against the first surface causes the malleable material to achieve the specified shape;
wherein the press die is formed from a polymer composition comprising:
an amorphous thermoplastic;
a first filler material, distributed in the amorphous thermoplastic, comprising particles having a first average dimensional aspect ratio; and
a second filler material, distributed in the amorphous thermoplastic, comprising particles having a second average dimensional aspect ratio different from the first average dimensional aspect ratio by at least a factor of two.

21. The press die of claim 20 wherein the first filler material comprises elongated particles having a first aspect average dimensional aspect ratio greater than 10:1.

22. The press die of claim 21 wherein the first filler material comprises elongated fiber particles made of at least one of the group consisting of: glass, carbon, cellulose, mineral, and polymer fibers.

23. The press die of claim 21 wherein the first filler material comprises substantially rigid fibers.

24. The press die of claim 20 wherein the second filler material comprises substantially round particles having a second average dimensional aspect ratio of approximately 1:1.

25. The press die of claim 21 wherein the second filler material comprises substantially round particles having a second average dimensional aspect ratio of approximately 1:1.

26. The press die of claim 25 wherein the second filler material comprises hollow spheres.

27. The press die of claim 25 wherein the second filler material is made of at least one material from among the group consisting of: glass microspheres, pumice, expanded ash, cenospheres, and polymeric microspheres.

28. The press die of claim 20 wherein the weight proportion of the first filler material is greater than or equal to 10% and the weight proportion of the second filler material is greater than or equal to 5%.

29. The press die of claim 1 wherein the composition exhibits a compressive strength greater than 70 MPa.

30. A process for manufacturing a sheet metal forming tool for use in a sheet metal press comprising:
with a thermoplastic feedstock material comprising an amorphous polymer, a first filler material having elongated particles and a second filler material having substantially non-elongated particles, performing an additive manufacturing process of heating, extruding and depositing the thermoplastic feedstock material in successive layers to construct the sheet metal forming tool;
wherein the proportion of the first and second filler materials are adjusted so that the sheet metal forming tool exhibits a compressive strength greater than 70 MPa and a compressive modulus greater than 4 GPa.
